(19) United States
(12) Patent Application Publication
(10) Pub. No.: US 2008/0185086 A1
(43) Pub. Date: Aug. 7, 2008

(54) Rotary Union Assembly For Use In Air Pressure Inflation Systems For Tractor Trailer Tires

(75) Inventors: Anthony L. Ingram, Guthrie, OK (US); Johnathan G. Jones, Edmond, OK (US)

Correspondence Address: HOLLAND & KNIGHT LLP, 633 WEST FIFTH STREET, TWENTY-FIRST FLOOR, LOS ANGELES, CA, 90071-2040, US

(73) Assignee: Airgo IP, LLC, Guthrie, OK (US)

(21) Appl. No.: 11/963,612

(22) Filed: Dec. 21, 2007

Related U.S. Application Data
(63) Continuation of application No. 11/051,314, filed on Feb. 4, 2005, now abandoned.
Application No. 11/051,314 is a continuation-in-part of application No. 10/851,441, filed on May 21, 2004, now Pat. No. 6,968,882.
Application No. 10/851,441 is a continuation of application No. 09/993,019, filed on Nov. 13, 2001, now abandoned.
Application No. 09/993,019 is a continuation of application No. 09/522,623, filed on Mar. 10, 2000, now Pat. No. 6,585,019.
Application No. 09/522,623 is a continuation of application No. 09/079,571, filed on May 14, 1998, now Pat. No. 6,105,645.
Application No. 09/079,571 is a continuation-in-part of application No. 10/941,774, filed on Sep. 15, 2004, now Pat. No. 7,117,909.
Application No. 10/941,774 is a continuation-in-part of application No. 10/457,793, filed on Jun. 9, 2003, now Pat. No. 6,938,658.

(51) Int. Cl. B60C 23/00; B60C 29/06; B60B 27/02; F16N 99/00

(52) U.S. Cl. 152/417; 301/105.1; 184/5.1

(57) ABSTRACT

A rotary union assembly for an automatic tire inflation system for maintaining the pressure in the tires on a tractor trailer or other vehicle having a source of pressurized air for communication with the tires. The assembly communicates the tires with the air source through the axle interior using a conduit having a rigid portion and a flexible portion that extends between a support in the axle spindle and a rotary union housing secured against the outside end surface of the hub cap so as to be outside the wheel lubrication compartment and rotatable with the hub cap. The two-component conduit allows for a durable seal with the support in the axle spindle and accommodates misalignment of the rotary union housing with the conduit support. Relief valves in the housing prevent excessive pressure buildups in the housing and in the hub cap in the event of an air leak.

### CROSS REFERENCE TO RELATED APPLICATIONS

This is a continuation of pending application Ser. No. 11/051,314 filed Feb. 4, 2005, entitled Rotary Union Assembly For Use In Air Pressure Inflation Systems For Tractor Trailer Tires, which is a continuation-in-part of application Ser. No. 10/851,441 filed May 21, 2004, now U.S. Pat. No. 6,968,882 issued Nov. 29, 2005, which is a continuation of application Ser. No. 09/993,019 filed Nov. 13, 2001 (now abandoned), which is a continuation of application Ser. No. 09/522,623 filed Mar. 10, 2000, now U.S. Pat. No. 6,585,019 issued Jul. 1, 2003, which is a continuation of application Ser. No. 09/079,571 filed May 14, 1998, now U.S. Pat. No. 6,105,645 issued Aug. 22, 2000. This is also a continuation-in-part of application Ser. No. 10/941,774 filed Sep. 15, 2004, now U.S. Pat. No. 7,117,909 issued Oct. 10, 2006, entitled Expandable Spindle Plug Assembly For use With Automatic Tire Inflation Systems, which is a continuation-in-part of application Ser. No. 10/457,793 filed on Jun. 9, 2003, now U.S. Pat. No. 6,938,658 issued Sep. 6, 2005.

### BACKGROUND OF THE INVENTION

The present invention relates to an improved rotary assembly for use in a central tire inflation system for automatically maintaining the inflation pressure of the pneumatic tires on moving vehicles such as tractor trailers and, more particularly, to an improvement in the rotary union assembly that is the subject of U.S. Pat. Nos. 6,105,645 and 6,585,019.

The central tire's inflation systems employed on typical tractor trailers utilize the air compressor on the tractor as a source of pressurized air to fill a leaking tire while the trailer is in motion. The compressor directs air to the reserve air brake tank on the trailer and is set to maintain the air pressure within the tank within a range of about 100 to 125 psi, which generally corresponds to the range of typical inflation pressures in the tires used on large tractor trailers. Air from the reserve air brake tank is first directed to the braking system to maintain the air pressure in the braking system at the normal brake system level of about 70 psi. Excess air is directed from the tank through a pressure protection valve to a control box for the tire inflation system. The pressure protection valve only opens to direct the air to the control unit when the air pressure in the tank exceeds 70 psi, thereby preventing air from being directed to the air inflation system which is needed for the trailer braking system. The control box contains a pressure regulator which is set to the cold tire pressure of the particular tires on the trailer so as to supply air to the tires at the desired pressure level in the event of a leak. Air is directed from the control box to the leaking tire through one of the trailer axles, which either carries an air line from the control box, or is sealed and functions as an air conduit. The pressurized air carried by the axles communicates with each pair of trailer tires mounted thereon through a rotary union assembly by which air flow is directed from a stationary air line to the valve stems on the rotating tires. Pressure responsive valves are employed between each rotary union assembly and its associated tires so that upon the occurrence of a leak in one of the tires, the resulting pressure loss will cause one of the valves to open and allow air flow from the rotary union assembly to pass there through to the leaking tire.

While these central tire inflation systems are well known and in widespread use, they suffer from several shortcomings. The rotary union assemblies employed in these systems have a relatively limited useful life span before the rotary seals begin to leak. The rotary seals, or rotary unions as they are frequently called, which are employed in these assemblies are generally located within the wheel lubrication compartments adjacent the ends of the axles. Accordingly, any air leakage in the rotary union seals causes an air pressure build up within the lubrication compartment which can damage the oil seals therein, and create an oil leak. If the wheel bearings loose their lubrication, they will seize up and can cause a fire. In addition to creating the potential for a dangerous fire, the positioning of the rotary union within the lubrication compartment of the wheel makes accessibility to the elements comprising the rotary union both difficult and awkward. As a result, the costs of repair and replacement are significantly increased.

The present invention provides a rotary union assembly for automatic central tire inflation systems which exhibits a substantially longer life than the rotary union assemblies heretofore in use. In addition, the assembly is configured so as to position the rotary union outside of the lubrication compartment for the vehicle wheels and thus avoids pressure build ups within the compartment in the unlikely event of a leak in the rotary union seal. The assembly also contains pressure relief valves which will avoid pressurizing the bearings within the assembly housing in the event of a leak in the rotary union seal, will prevent a pressure build-up within the lubrication compartment in the hub in the event of an air leak upstream of the rotary union seal, and will prevent outside water from entering into the hub. The assembly of the present invention additionally provides ready access to the rotary union components thereof without having to enter the lubrication compartment to facilitate part replacement. As a result, the present invention provides a substantial improvement in air pressure maintenance systems for tractor trailer tires.

Other problems facing central tire inflation systems include a lack of uniformity in tractor trailer wheel hub cap configurations and off center mountings. The former situation results in variations in the axial distance between the ends of the axle spindles and end walls of the hub caps. This distance generally determines the spacing between the air inlet, of the assembly and the rotary seal therein. It would be highly desirable to provide a rotary union assembly which could readily accommodate such dimensional variations and thereby obviate the need to provide differently sized assemblies or replacement components for different hub cap configurations. The rotary union assembly should also accommodate off center alignments of the axle spindle and hub caps without incurring additional wear on the air seals in the assembly which further shortens the life of the assembly. The rotary union assembly of the present invention achieves these objectives as well.

### SUMMARY OF THE INVENTION

Briefly, the present invention is directed to a rotary union assembly for use in automatic tire inflation systems for vehicle tires and, particularly, for use in automatic inflation systems employed on tractor trailers having either pressurized or non-pressurized stationary axles. The rotary union assembly of the present invention communicates the valve stems on a pair of adjacent tires with either the pressurized axle interior or directly with the source of pressurized air through the use of a stationary tubular conduit, at least a downstream portion of which is flexible. In pressurized axle applications, the upstream end of the tubular conduit extends through a stationary annular seal mounted in a plug assembly in the axle spindle and communicates with the axle interior. The downstream portion of the conduit communicates with a rotary union housing containing the rotary union seal. In non-pressurized axle applications, the upstream end of the tubular conduit preferably communicates directly with the pressurized air supply by means of a flexible air hose that communicates with the tubular conduit through the plug assembly and extends therefrom to the pressurized air supply through the axle interior.

In both pressurized and non-pressurized axle applications, the rotary union housing is sealably secured against the exterior surface of the end wall of the hubcap so as to be rotatable with the hubcap and tire. The annular seal in the plug assembly forms an airtight seal about an upstream position of the tubular conduit which is preferably rigid to prevent distortion of the conduit over time. In addition, the annular seal allows for the length of the rigid portion of the tubular conduit projecting from the annular seal toward the rotary union housing to be readily varied by the simple insertion or retraction of the conduit from the plug assembly during installation, thereby accommodating wide variations and hubcap configurations without the need for part replacement and without adversely affecting the integrity of the seal. As both the tubular conduit and the annular seal through which it extends are stationary and the portion of the tubular conduit which the annular seal engages is rigid, wear it is virtually eliminated at this juncture of the assembly.

In a preferred embodiment of the invention, a portion of the tubular conduit between the plug assembly and rotary union housing is flexible. Thus, inadvertent off center mountings of the rotary housing relative to the threaded fitment on the axle spindle is readily accommodated without significantly affecting either the integrity or the life of the air seals in the assembly. Positioning the rotary housing against the exterior end surface of the hub cap locates the rotary seal formed therein outside of the lubrication compartment of the wheel and thereby prevents pressure build ups within the lubrication compartment in the event of air leakage in the rotary seal.

The rotary seal of the present invention includes a stationary shaft having an air passageway extending axially therethrough that communicates with the downstream end of the air conduit. The shaft projects through and is carried by one or more bearing members disposed in an extended portion of the rotary union housing. The extended portion of the housing projects axially through the hub cap end wall such that the shaft communicates the pressurized air passing through the tractor trailer axle with the interior of the rotary housing via the tubular conduit while providing a rotatable mounting of the rotary housing on the stationary shaft. A spring biased graphite element having a centrally disposed axial passageway is mounted in a fixed disposition within the housing so as to be rotatable therewith. The element is pressed against the downstream end of the elongated shaft in a flush disposition therewith to form with the shaft a rotary union by which air flow passes from the stationary tubular conduit into the rotating housing.

In the rotary housing mounted on the end wall of the hub cap, air is directed from the rotary union through two opposed channels into separate air lines which communicate with the valve stems on the pair of adjacent tires or, in the case of wide-based tires, through a single channel and air line to the valve stem on the single tire. Pressure responsive valves are provided in each of the lines to allow air flow through the appropriate line in response to a downstream pressure drop as would occur in the event of a leak in one of the tires. A normally open pressure responsive valve is also provided in each line which closes in the event of a drop in pressure upstream of the rotary union as would occur when the compressor is shut down to prevent the trailer tires from deflating. A warning light is also provided in the system for indicating to the driver the activation of the central tire inflation system.

A pressure relief valve system comprising at least one calibrated poppet valve is provided in the rotary union housing for venting both the rotary union and the lubrication compartment to atmosphere to avoid pressurizing the bearings within the housing in the event of a leak in the rotary union seal and to prevent a pressure build up within the lubrication compartment in the event of an air leak in the tire inflation system upstream of the rotary union seal. The valve system is configured to prevent outside water from entering into the hub in the event the rotary union housing is submerged in water or is subjected to high pressure washing and to resist oil from the lubrication compartment within the hub cap from passing therethrough and onto the vehicle wheels while discharging air therethrough.

### BRIEF DESCRIPTION OF THE DRAWINGS

FIG. 1 is a partial perspective view of the rotary union assembly of the present invention shown secured to a hub cap on the outer wheel of a pair of tractor trailer tires mounted on a stationary pressurized axle.

FIG. 2 is a partial perspective view of the rotary union assembly of the present invention shown secured to a hub cap on the outer wheel of a pair of tractor trailer tires mounted on a stationary non-pressurized axle.

FIG. 3 is an exploded perspective, view of the components of a preferred embodiment of the rotary union assembly of the present invention.

FIG. 4A is a sectional side view of the preferred embodiment of the rotary union assembly of the present invention and associated spindle plug assembly and axle spindle in a pressurized axle application.

FIG. 4B is a sectional side view of the preferred embodiment of the rotary union assembly of the present invention and associated spindle plug assembly and axle spindle in a non-pressurized axle application.

FIG. 5 is a partial side view of the rotary union housing, one of the air lines and the associated valves which are employed in the rotary union assembly of the present invention.

FIG. 6 is an exploded perspective view of the preferred embodiment of the rotary union shaft, associated bearings, connectors and the tubular conduct.

FIG. 7 is a rear plan view of the rotary union housing.

FIG. 7A is a sectional view of the rotary union housing taken along the line 7A-7A in FIG. 7.

FIG. 7B is a sectional view of the rotary union housing taken along the line 7B-7B in FIG. 7.

FIG. 8 is a perspective view of a hub cap having a sight glass adjacent the end wall thereof that is adapted for use with the rotary union assembly of the present invention.

FIG. 9A is a side view of a preferred embodiment of one of the poppet valve members slidably mounted in the rotary union housing.

FIG. 9B is a sectional view of the poppet valve member illustrated in FIG. 9A.

FIG. 10 is a sectional side view of the preferred embodiment of the rotary union assembly mounted on a hub cap particularly configured for use with the present invention.

FIG. 11 is an exploded perspective view of a two-piece ring assembly for mounting the rotary union assembly of the present invention on different hub caps.

FIG. 12 is a sectional side view of the center hub of the ring assembly illustrated in FIG. 11.

FIG. 13 is a perspective view of the center hub of the ring assembly illustrated in FIG. 11.

### DESCRIPTION OF THE PREFERRED EMBODIMENTS

Referring now in detail to the drawings, the rotary union assembly 10 of the present invention, while useable on a wide variety of movable vehicles employing stationary axles for automatically maintaining the inflation pressure of the pneumatic tires thereon, is particularly adapted for use on tractor trailers. Accordingly, the assembly 10 will be described in conjunction with a pair of adjacent vehicle tires 12 and 14 mounted on a stationary tractor trailer, axle 16. While identical rotary union assemblies 10 are provided at the end of each axle on the trailer to maintain the inflation pressure of the tires carried thereby, reference will be made to only one such assembly and the pair of tires it services.

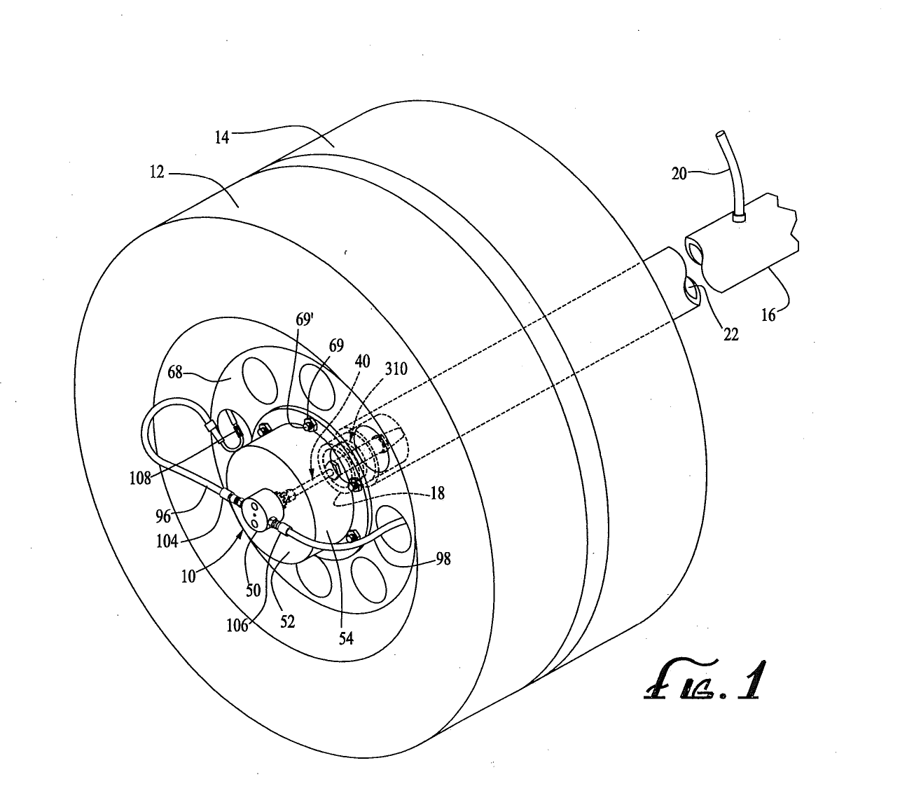

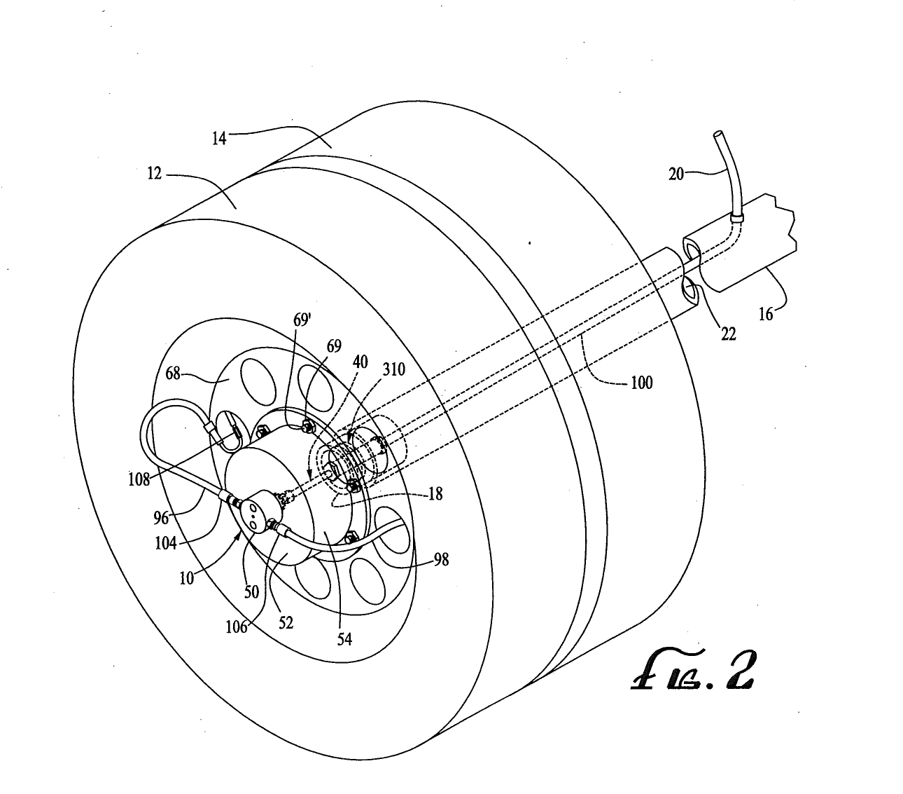

The trailer axle 16 which carries tires 12 and 14 can be sealed and functions as an air conduit to communicate the spindles 18 welded to the extended ends of a trailer axle 16 with an air supply line 20. Such an arrangement is referred to herein as a sealed or pressurized axle application and is illustrated in FIG. 1. The rotary union assembly 10 can also be used on non-sealed (non-pressurized) axles as illustrated in FIG. 2. As will be seen, the configuration and operation of the rotary union assembly is basically the same in both pressurized and non-pressurized axle applications.

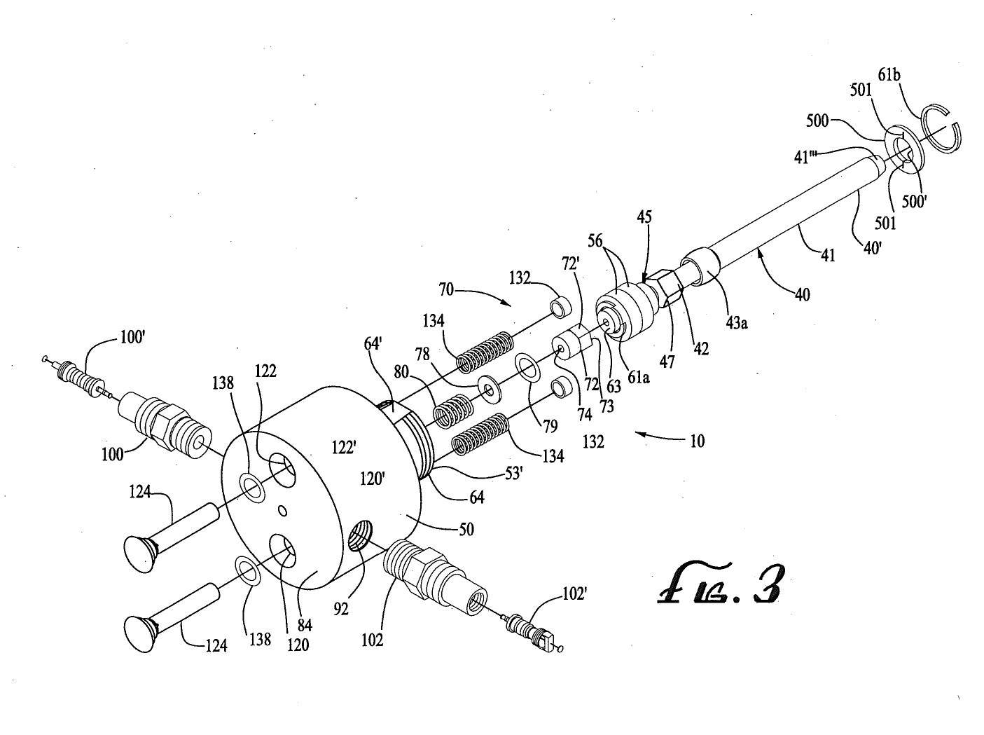

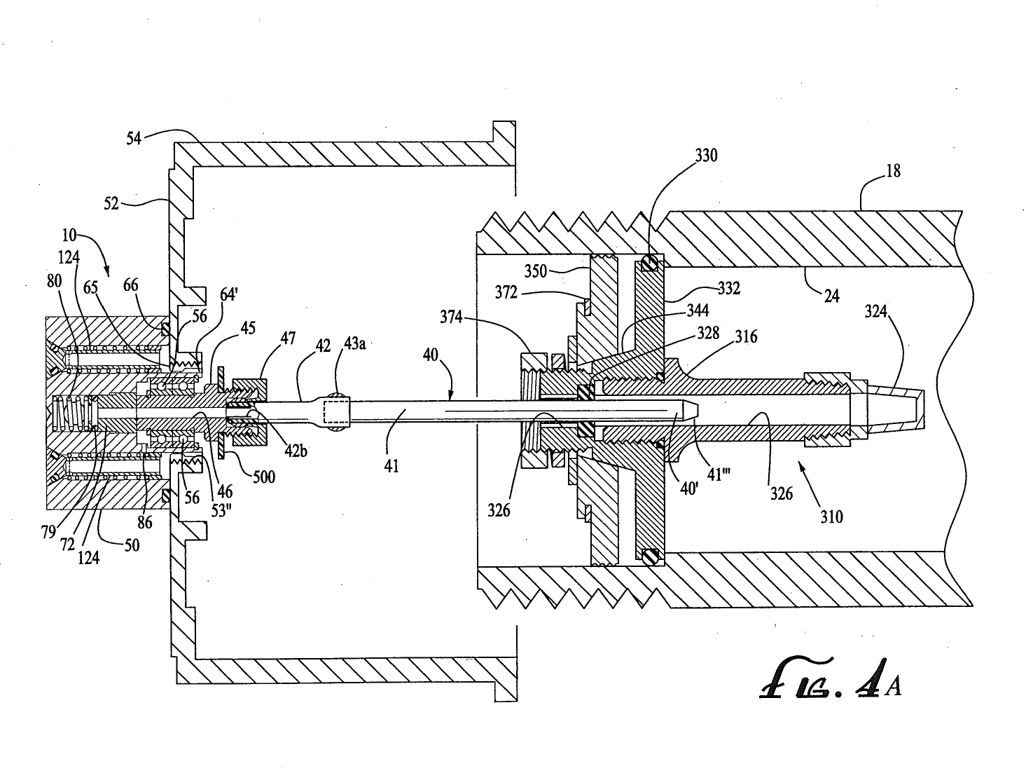

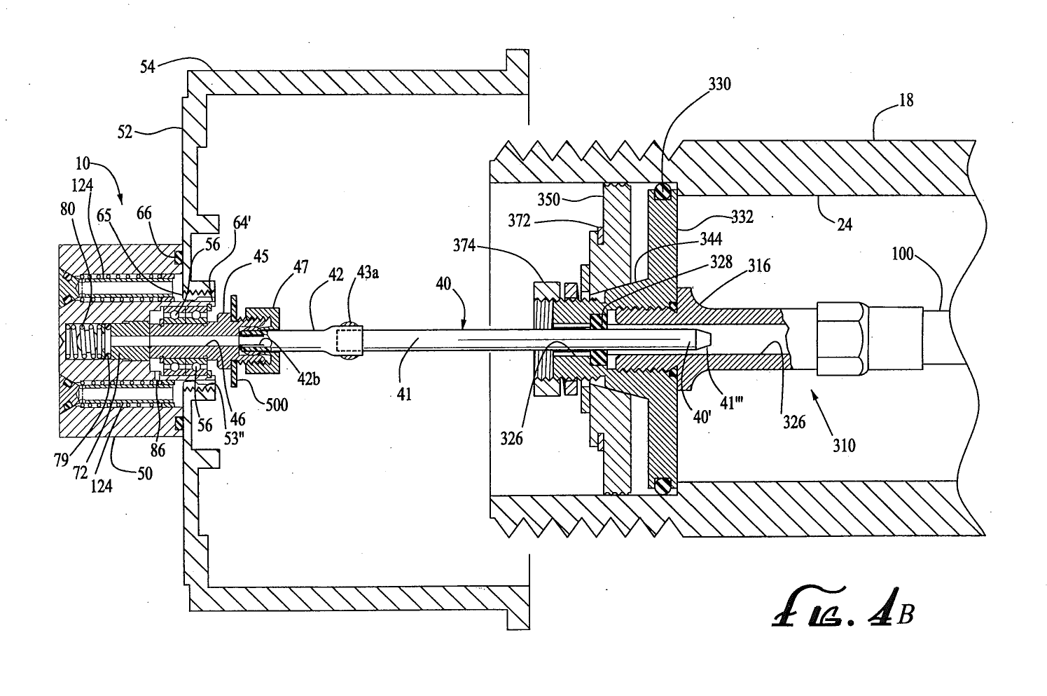

In pressurized axle applications (FIG. 1), an air supply line 20 provides air under pressure to the interior of axle 16 from the conventional air compressor on the tractor via a standard pressure protection valve and control box (not shown) to pressurize the axle at the cold tire pressure of the trailer tires. As seen in FIGS. 2 and 4, the axle spindle 18 has a centrally disposed conduit extending axially therethrough which terminates at its downstream end in an enlarged cylindrical bore 24. A conduit support 310, preferably in the form of a spindle plug assembly, is sealably secured in bore 24 for the purpose of communicating the rotary union assembly 10 with the axle interior. While numerous embodiments of spindle pug assemblies, fittings and other conduit supports could be employed with the rotary union assembly of the present invention, preferred embodiments are disclosed in U.S. Pat. No. 7,117,909 issued Oct. 10, 2006 and entitled Expandable Spindle Plug Assembly for Use With Automatic Tire Inflation Systems, the teaching of which are hereby incorporated by reference as though fully set forth herein.

Briefly, the spindle plug assembly 310 (as seen in FIGS. 4A and 4B herein) is comprised of an arbor 316 defining a circular flange 322 carrying an o-ring seal 330 in a groove formed in the perimeter of the flange to provide an air tight seal with the spindle wall. An expandable split ring locking assembly 350 comprised of individual ring segments held together by a split ring retainer spring 372 is slidably mounted on a tapered or inclined portion 344 of the arbor. When a fastening member at 374 is tightened about the downstream end portion of the arbor, the split ring assembly 350 is forced upstream along the inclined arbor portion 344, causing the individual ring segments of the assembly 350 to move radially outwardly against the force of the split ring retention spring until the sharp ridge edges on the outer surface of the split ring assembly abut and dig into the inner steel surface of the axle spindle 18, securing the spindle plug assembly 310 in place within the axle spindle. The spindle plug assembly of 310 also carries an interior annular seal 328 disposed about an axially extending central channel 326 which forms an air tight seal about a stationary tubular conduit 40. The upstream end 40′ of the tubular conduit 40 communicates with the arbor channel 326 and, in sealed axle applications (FIGS. 1 and 4A), communicates with the interior of the axle spindle 18 through a filter element 324 readily affixed to the upstream end of the arbor 316. In non-sealed axle applications (FIGS. 2 and 4B), the upstream end of tubular conduit 40 communicates via arbor channel 326 with a flexible air hose 100 that is affixed to the upstream end of arbor 316 in lieu of filter element 324 and extends through the axle to the air supply line 20 or, alternatively, through the axle directly to the control unit. Thus, in both sealed and non-sealed applications, pressurized air from the air compressor is directed through the axle to and through the spindle plug assembly 310 to the stationary tubular conduit 40.

In a preferred embodiment of the invention, the tubular conduit 40 is comprised of a rigid stainless steel portion 41 and a relatively short flexible portion 42 secured to the downstream end of rigid portion 41 by a crimped ferrule 43a. Alternatively, the rigid and flexible portions of conduit 40 could be integrally formed in a molding process to obviate the need for ferrule 43a or some other suitable fitting. The rigid portion 41 of conduit 40 is preferably provided with a tapered upstream end 41′″ and projects into the interior of the axle spindle through the o-ring seal 328 in the spindle plug assembly 310 as seen in FIG. 4. By way of example, rigid portion 40 is about 3.25 inches in length. By forming the tubular conduit of a rigid material, distortion thereof over time by the annular seal 52B is prevented. By forming a portion of the conduit with a flexible material in the preferred embodiment of the invention, off center mountings of the rotary housing relative to the threaded fitment on the axle fitment is accommodated as noted earlier herein. The flexible tubing portion 42 shown in the drawings is preferably constructed of a nylon or plastic material or a fluoropolymer resin material such as that marketed by DuPont under its registered trademark Teflon, is about 1.0 in. in length and defines a wall thickness of about 0.05 in. Preferably, the flexible portion 42 of conduit 40 is reinforced with nylon, Teflon® or other suitable fibers embedded therein to provide additional strength to withstand any physical abuse during cleaning or part replacement. Flexible conduit portion 42 is positioned downstream of the interior seal 328 in the spindle plug assembly 310 and is sealably secured to a rotary union shaft 45 axially aligned with tubular conduit 40 by a ferrule 43b disposed within threaded fitting 47. A stainless steel tubular insert 42b preferably having a radial flange at its downstream end is preferably provided within the downstream end of flexible conduit portion 42 so that the conduit is not deformed by the squeezing of ferrule 43b by nut 47. The rotary union shaft 45 defines an axially disposed air channel 46 extending therethrough communicating with tubular conduit 40.

To prevent axial separation and relative rotation between the rigid and flexible portions of tubular conduit 40, tapered axial ribs 41′ are provided on the downstream end of the rigid conduit portion 41 adjacent annular hose barbs 41″. Hose barbs 41″ extend into the upstream end portion of flexible tubing portion 42 of conduit 40 which is secured therein by the crimped ferrule 43. The upstream portion of the rotary union shaft 45 defines a threaded tubular extension 45′ that threadably engages the compression fitting 47. It is to be understood that other suitable attachment fittings could be employed to sealably engage the flexible portion 42 of the tubular conduit 40 with the rigid portion 41 and with the rotary union shaft 45.

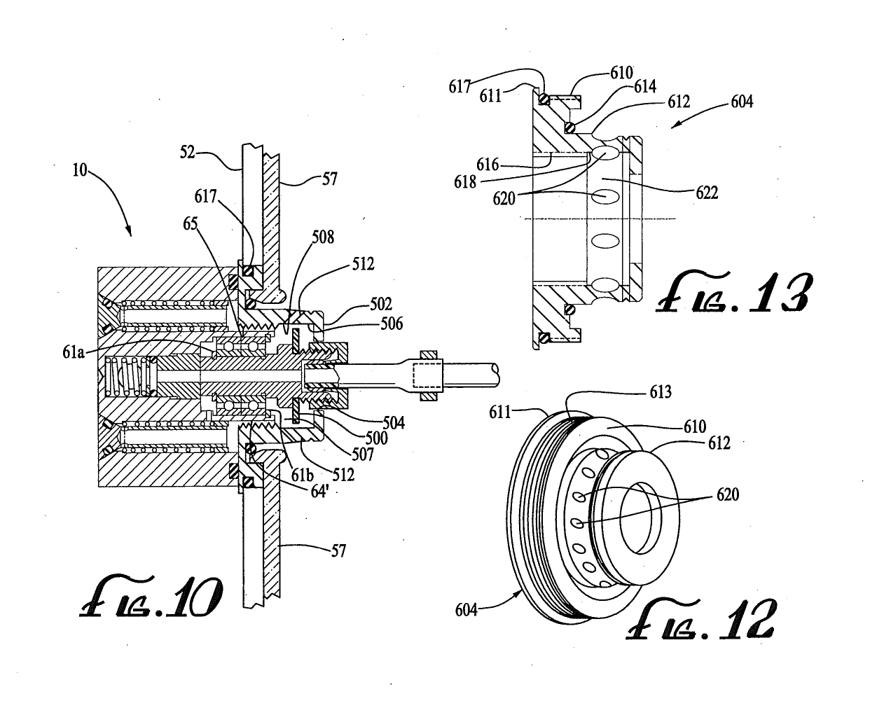

The rotary union shaft 45 projects into a rotary housing 50 which is mounted exteriorly adjacent end wall 52 of hub cap 54. Rotary union housing 50 includes a central channel 58 extending axially therethrough for receiving shaft 45 and the other components of the rotary union 70, also referred to as a rotary union seal. A pair of high quality self-lubricating bearings 56 are mounted within housing 50 about a portion of channel 58 which receive in a press fitment a downstream portion 59 of the shaft 45 so as to provide a freely rotational mounting of the rotary housing 50 on shaft 45. Bearings marketed by NTN Bearing Corporation of America of Mt. Prospect, Ill. under the model designation W688AZZ/1K have been found to be well suited for this application. The bearings 56 are secured in place within housing 50 by a pair of clips 61a and 61b (see FIGS. 3 and 10). The downstream portion 59 of shaft 45 which projects through bearings 56 is of a reduced diameter to define a bearings abutment shoulder 62 and a flat highly polished end face 63, finished at 8 or better.

An upstream portion 64 of the rotary housing 50 is of a reduced diameter and projects through a centrally disposed aperture 65 in the end wall of hub cap 54 such that the rotary housing can be sealably secured against the exterior end wall 52 of hub cap 54 in axial alignment with the hub cap, rotary union shaft 45 and tubular conduit 40. This securement can be provided by an annular resilient seal 66 carried in an annular channel 85′ formed in the upstream end 85 of the rotary union housing and mating threads 53′ formed on the exterior of the reduced diameter portion 64 of rotary housing 50 and threads 53″ formed in hub cap end wall 52 about central aperture 65 therein. Upon threadably securing the rotary union housing onto the hub cap end wall, seal 66 abuts and sealably engages an annular portion of the wall about the central opening or aperture 65 therein. Unless the hub cap is particularly designed for use with the rotary union assembly of the present invention, such as hub cap 54 shown in the drawings, the above-described securement of housing 50 generally requires the drilling and tapping of aperture 65 in the end wall of the hub cap. It should be noted, however, that the end walls of some hub caps are too thin to support the rotary union housing 50 as described. For such installations, the aperture 65 is drilled but not tapped and a suitably sized threaded fastening member in the form of a large nut (not shown) threadably engages the reduced diameter portion 64 of the housing within the hub cap and is tightened against the interior surface of the hub cap end wall about the aperture therein, securing the housing to the hub cap end wall.

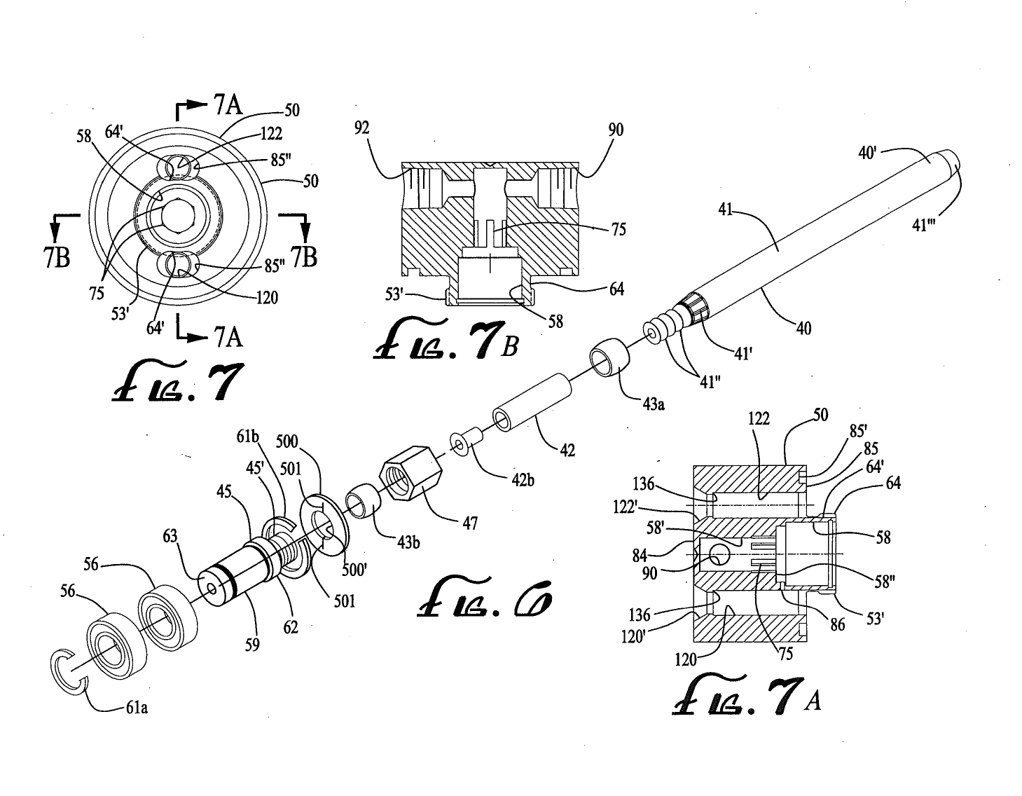

It also should be noted that many hub caps of the type with which rotary union assemblies are employed have a “sight glass” 57 mounted in the end wall 52 thereof for viewing the oil level within the hub cap, as is shown in FIG. 8. As seen therein, the hub cap end wall against which the rotary union housing is sealably secured is defined by a separate piece 52′ defining a web configuration with the threaded opening 65 being at the center of the web. The end piece 52′ is typically attached to the hub cap by a plurality of axially extending screws 53. In either case, the hub cap 54 is secured to the outer tire wheel 68 by means of the threaded engagement of the wheel lug nuts 69 with lug bolts 69′. Accordingly, rotation of tires 12 and 14 will effect rotation of the wheel hub cap 54 and rotary housing 50 with respect to the axially aligned and stationary shaft 45 and tubular conduit 40.

The rotary union or seal 70 in rotary housing 50 is defined by the stationary elongated shaft 45, an axially aligned graphite element 72 having an open ended channel 74 extending axially therethrough, a steel washer 78, an o-ring 79 disposed between washer 78 and the downstream end of the graphite element 72, and a coil spring 80 disposed within a reduced diameter downstream portion 58′ of housing channel 58. The graphite element defines a hexagonal upstream portion 72′, the corners of which fit within a plurality of equiangularly spaced axial relief areas 75 formed in the side wall of the reduced diameter portion 58′ of the flow through channel 58 in rotary housing 50 such that rotational movement of housing 50 with hub cap 54 is imparted to graphite element 72. Alternatively, the channel walls about reduced diameter portion 58′ could be hexagonally or otherwise configured to provide an interference fit with the graphite element 72. The coil spring 80 in the rotary union when compressed to 0.25 inches, produces spring force of about 5.5 to 6.0 pounds and bears against the end of the reduced diameter bore 58′ and washer 78 so as to urge the upstream planar end face 73 of graphite element 72 against the flush downstream adjacent planar end face 63 of the stationary shaft 45.

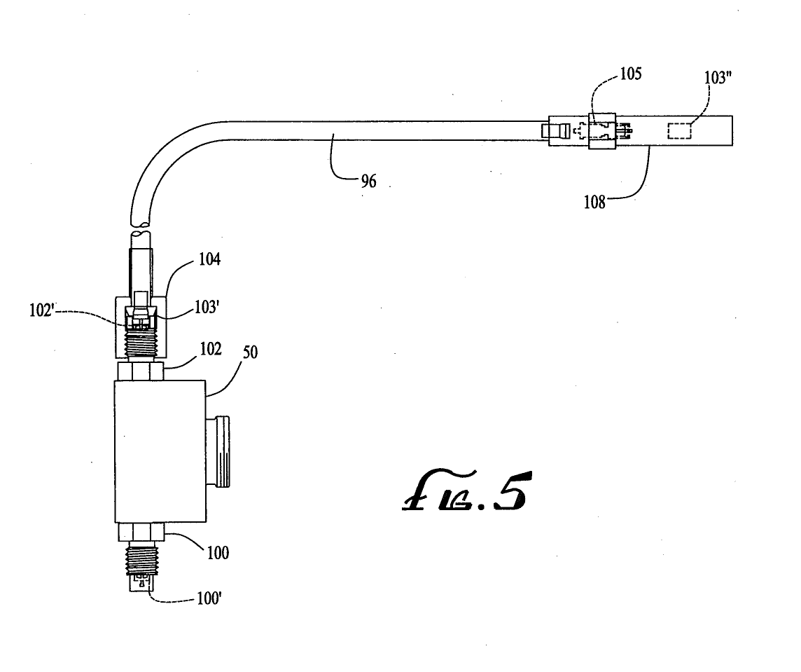

A pair of oppositely aligned radial channels 90 and 92 are provided in the rotary housing 50 which communicate with the central channel 58 therein proximate spring member 80 as seen in FIGS. 3 and 7B. Through the aforesaid configuration, air under pressure in axle 16 passes into and through the stationary tubular conduit 40, the stationary shaft 45 and into the rotating graphite element 72 which is being urged against the shaft 45 by spring member 80. The air then passes through element 72 and into housing channels 90 and 92 for direction to the trailer tires 12 and 14 via air lines 96 and 98 (see FIG. 5). The resulting rotary seal has been found to exhibit an extremely long life without leakage. By means of the threaded engagement of the rotary union housing 50 with the extension of the hub cap 54, ready access is provided to the interior of the rotary housing 50 and the elements comprising the rotary seal 70 disposed therein.

The opposed channels 90 and 92 in rotary housing 50 are provided with internal threads for the threaded engagement therein of fittings 100 and 102 containing Schraeder valves 100′ and 102′ respectively or other suitable check valves. (See FIG. 5). Valves 100′ and 102′ are held open by conventional check valve depressors 103′ (only one being shown) mounted in the air hoses 96 and 98 within knurled nut ends 104 and 106 carried thereby. Because valves 100′ and 102′ are normally disposed in an open position and are provided to prevent air from being blown to atmosphere in the event air hose 96 or 98 were removed, the opening pressure of valves 100′ and 102′ is not critical and could be about 90 psi or 3 psi. Mounted downstream and preferably within the fittings 108 that threadably engage the valve stems on the tires are a second pair of Schraeder valves 105 (only one being shown in FIG. 5) which are normally closed and have an opening pressure of about 3 psi. Air hoses 96 and 98 project in opposed directions from rotary housing 50 to the conventional valve stems (not shown) carried on tires 12 and 14. The threaded hose fittings 108 carried by downstream ends of air hoses 96 and 98 for threaded engagement with the tire valve stems are each provided with a check valve depressor 103″ such that upon threadably securing the air hoses to the valve stems, the check valves in the tire valve stems are maintained in an open disposition, thereby communicating the interior of tires 12 and 14 with air hoses 96 and 98. By providing valves 105 proximate the valve stems on the tires, the vehicle's tires will not loose air in the event of an air leak in the air line 96 or 98.

Through the aforesaid configuration, air under a pressure corresponding to that of the cold pressure of the vehicle tires 12 and 14 is provided from axle 16 through the rotary union assembly 10 and the open Schraeder valves 100′ and 102′ carried by the rotary housing 50. Because the air passing through valves 100′ and 102′ to valves 105 is at the same pressure as the air within tires 12 and 14, valves 105 are balanced and remain closed, preventing air flow through the rotary union assembly 10. In the event of a leak in one of the tires, the resulting pressure drop downstream in air hose 96 or 98 will create a pressure imbalance across the valve 105 mounted therein. As soon as this imbalance reaches 3 psi, the valve 105 will open, allowing air to pass therethrough to the leaking tire to maintain the desired inflation pressure within the tire. When the automatic air inflation system is shut down, the pressure within the axle remains at the tire inflation pressure. Accordingly, valves 105 remain balanced and closed so that the tires will not deflate. If the axle were to leak so that the pressure were to drop on the upstream side of valves 105, they would remain closed so that the tires would not release air to the depressurized chamber within the axle. If one were to remove one of hoses 96 or 98 from housing 50, as would occur if the hoses were damaged, valve 100′ or 102′ would close so that the system would not continually blow air to the atmosphere.

A pressure relief system is provided in the rotary union assembly 10 of the present invention which will: (1) avoid pressurizing the bearings 56 in the rotary union housing 50 in the event of an air leak in the rotary union 70 between the stationary end face 63 on the rotary union shaft 45 and the rotating planar end face 73 on the graphite element 72; and (2) prevent a pressure buildup within the lubrication compartment which could result in the event of air leak upstream of the rotary union. This pressure relief system comprises a pair of open ended channels 120 and 122 extending axially through the rotary union housing 50 parallel to and on opposite sides of the central housing channel 58. At least one of the channels (e.g. 120) communicates with the central housing channel 58 via a weep hole 86. The weep hole 86 is located such that it communicates with channel 58 adjacent a shoulder 58″ defining the interface of the reduced diameter portion 58′ of channel 58 with the larger diameter upstream portion and thus communicates with channel 58 adjacent the rotary union surfaces 73 and 63.

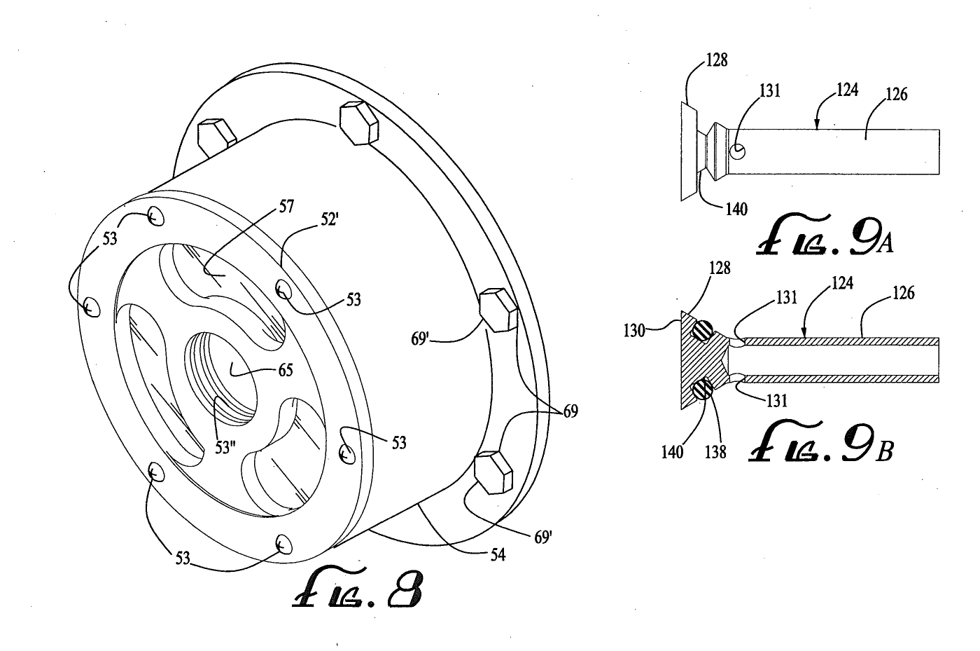

An elongated poppet valve member 124 is disposed in each of the pressure relief channels 120 and 122. Each valve member defines a hollow tubular body portion 126 and an enlarged radial head portion 128 having a flat outer surface 130. A pair of opposed air outlet apertures 131 extend transversely through the body portions of the valves proximate the head portions as seen in FIGS. 9A and 9B. The poppet valve members are sized with respect to the relief channels such that when disposed in the relief channels, the outer surfaces 128 of the head portions 126 are substantially flush with the outer end wall 84 of the rotary union housing and the tubular body portions 126 of the valves are inwardly spaced from the side walls of the relief channels. A cylindrical sleeve 132 is pressed about the extended upstream end of each of the poppet valves members and a coil spring 134 having a spring weight of about 0.109 lbs. is disposed within the relief channels about the body portions of the valve members. Each spring bears against the sleeve 132 at its upstream end and an annular shoulder 136 formed in the interior downstream ends of the relief channels. An o-ring 138 is provided in a recess 140 in the valve members adjacent the valve heads 128 so as to define air tight seals with the downstream ends of the relief channels 120 and 122 when the valve members are in the retracted or closed position. To effect such seals the surfaces of the outer end wall 84 of the rotary union housing 50 are counter-sunk about channels 120 and 122 to define tapered sealing surfaces 120′ and 122′ that abut the O-rings 138 carried by the poppet valve members 124. Through such a configuration, the poppet valves will pop to the open position, compressing the coil springs 134 between sleeves 132 and shoulders 136 when the pressure within one of the relief channels reaches 0.5 psi above atmospheric or the ambient air pressure.

To provide an air flow path for the pressurized air within the hub cap to the upstream ends of the pressure relief channels 120 and 122 with minimal restriction, opposed lateral portions of the threaded reduced diameter portion 64 of the rotary union housing 50 are cut away so as to define air passageways 64′ that allow the pressurized air to pass relatively unrestricted through the threaded engagement of the rotary union housing to the hub cap. Cut-out areas are also provided in the upstream end 85 of the housing 50 about the upstream ends of the relief channels, defining air collection areas 85′ adjacent the channels. The relief channels 120 and 122, valve members 124 and the outlet apertures 131 in the valve members are sized so as to be capable of passing a sufficient volume of air therethrough that in the event of a catastrophic failure, a pressure buildup within the lubrication compartment of no more than 5 psi will result given a pressurized air source of about 100-125 psi. This result was obtained with the present invention, by configuring the pressure relief system such that it could evacuate air from the hub cap at the same volumetric flow rate as a 0.250 inch diameter aperture in the hub cap wall open to atmosphere. To obtain that result, the relief channels 120 and 122 each defined a transverse dimension of 0.253±0.003 inches. The internal diameters of the poppet valve members was 0.125 in. The diameters of each of the outlet apertures 131 in each valve member was 0.063 in. and the inner diameter of the rigid portion 41 of conduit 40 was 0.086 inches.

Accordingly, in the unlikely event of an air leak through the rotary union 70 sufficient to create a pressure buildup within channel 120 of as little a 0.5 psi, the poppet valve member 124 disposed in relief channel 120 will snap to the open position allowing the air in the chamber to discharge to atmosphere through the aperture 131 in the valve member. In the event of an air leak upstream of a rotary union which would otherwise cause a pressure buildup within the oil lubrication compartment, air will flow directly from the lubrication compartment along the air passageways 64′ between the threadably engaged rotary union housing and hub cap and into the pressure relief channels 120 and 122. When this pressure build-up exceeds 0.5 psi, the force of the coil springs 134 holding the poppet valve members 124 in their closed positions will again be overcome and the valve members will snap to their open positions, relieving the pressure within the lubrication compartment. Thus, the pressure relief poppet valves will prevent any deleterious pressure buildup within either the rotary union housing or the lubrication compartment within the hub cap. In addition, in the event the rotary union housing were submerged in water or subjected to high pressure water cleaning, the spring leaked poppet relief valves would prevent any water from entering the rotary union housing or the wheel lubrication compartment.

While the preferred embodiment of the present invention employs two symmetrically positioned pressure relief valves, only one of which needs to be communicated with the central housing channel via a weep hole 86, the rotary union housing could be constructed so as to include only a single relief channel and poppet valve member, provided the housing was configured such that the relief channel would be large enough to discharge the necessary volumetric flow of air to prevent a pressure buildup in the lubrication compartment of over 5 psi. The preferred configuration of the rotary union housing employs two poppet relief valves to allow for such a discharge without having to increase the size of the housing.

Because pressure relief channels 120 and 122 communicate with the interior of the hub cap as previously described, oil in the lubrication compartment within the hub cap can, under pressure, pass into the pressure relief channels. As a result, when the interior pressure within the hub cap exceeds 0.5 psi above atmospheric and the poppet valves open to relieve the pressure, oil from the hub cap will flow through and about the valve members 124 with the escaping air and onto the vehicle wheels. To prevent such a messy and unsightly occurrence, an oil shield 500 is disposed about the upstream end portion of the rotary union shaft 45 adjacent compression fitting 47. Shield 500 is thus positioned directly in the path of any oil being expelled from the hub cap under pressure toward the upstream ends of air passageways 64′ to relief channels 120 and 122. The shield 500 is in the form of a washer preferably made of a fluoropolymer resin material such as that marketed by DuPont under its registered trademark Teflon, and is preferably provided with radial slots 501 about its central opening 500′ so that the shield can be more readily pressed into place about the upstream end portion of shaft 45.

In the preferred embodiment of the invention, the end wall of the hub cap is further modified (see FIG. 10) so as to define an inwardly facing annular planar surface 502 disposed about a central opening 504 and an outwardly facing annular shoulder 506 also disposed about opening 504. The oil shield 500 is disposed outwardly adjacent shoulder 506 and is spaced about 0.020 in. therefrom. Opening 504 is axially aligned with the centrally disposed threaded opening 65 in the end wall of the hub cap but is of a slightly reduced diameter. By way of example, threaded opening 65 defines a diameter of about 0.875 in. and aperture 504 defines a diameter of about 0.585 in. A radially offset annular wall 508 extends between annular shoulder 506 and opening 65 so as to define an annular oil collection area 507 as seen in FIG. 10. A plurality of apertures 512 (twelve being shown) are formed in and equally-spaced about an annular wall 508 circumscribing an annular oil collection area 507. Apertures 512 are of sufficient size (e.g. 0.109 in. in diameter) to allow 90 wt. oil to pass readily therethrough and are inclined at an angle of about 45° with respect to the common central axis of openings 65 and 504.

As a result of the above-described pressure relief assembly, any oil passing under pressure toward the cut-out air passageways 64′ in the threaded portion 64 of the rotary union housing will abut shield 500 and be deflected or drip into the annular oil collection area 507 and is thus prevented from passing directly through the air passageways to the pressure relief channels 120 and 122. Because the hub cap is rapidly spinning as the vehicle travels along the road, centrifugal force will cause the oil in area 507 to be driven outwardly against annular wall 508, through the inclined apertures 512 therein and back into the interior of the hub cap. As a result, the passage of oil through the rotary union housing and onto the exterior of the vehicle wheel is substantially diminished during an air leak. The apertures 512 in the annular wall 508 are inclined at about a 45° angle as above described so as to enable the apertures to communicate with the interior of the hub cap inwardly of the sight glass 57 in the end wall of the hub cap and to direct the returning oil outwardly within the hub cap, away from the rotary union shaft. When the hub caps with the preferred embodiment of the rotary union assembly of the present invention are being used do not have a sight glass, it is not necessary to incline the oil return apertures 512 as above described. However, by still inclining the apertures, the centrifugal force acting on the collected oil will drive the oil rearwardly as well as outwardly within the hub cap interior and thus further from air passageways 64′.

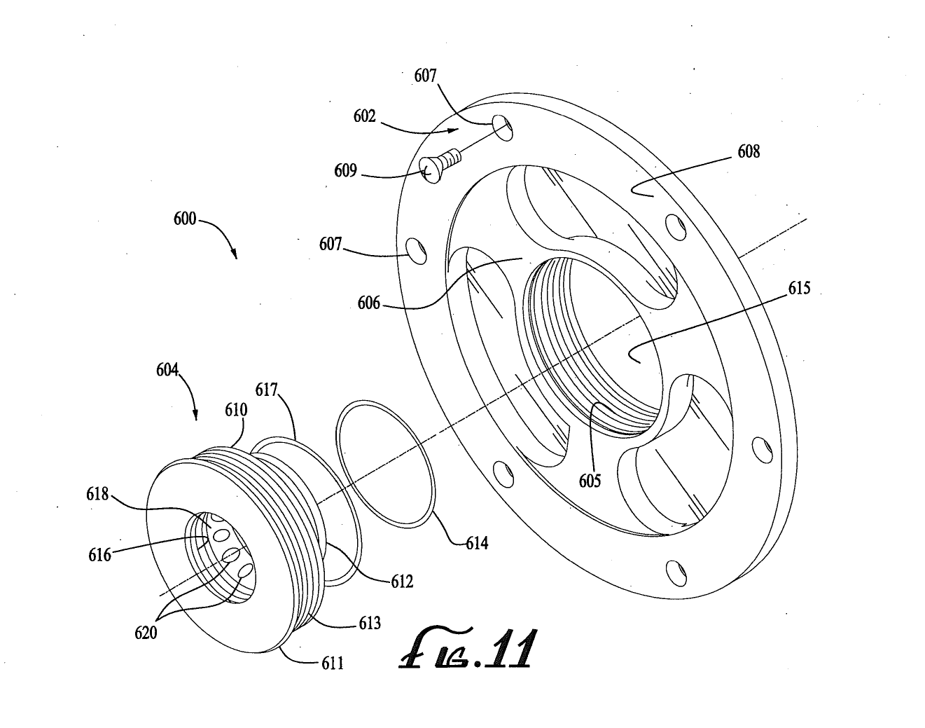

To facilitate the use of the preferred embodiment of the rotary union assembly of the present invention with a wide variety of hub caps, both with and without sight glasses, a two-piece ring assembly 600 has been developed. As shown in FIGS. 11-13, the assembly 600 comprises an end ring 602 and a center hub 604 and provides the same above-described securement of the housing assembly to the hub cap while minimizing the retrofitting of the existing hub cap and still taking full advantage of the pressure relief features of the present invention.

For hub caps that do not have a sight glass in the end wall, the end ring 602 of assembly 600 is not needed. In such applications, it is only necessary to form a centrally disposed threaded aperture defining a diameter of 1.625 inches in the hub cap end wall. In hub caps having sight glasses, the same enlarged threaded opening 605 is provided in the end ring 602 which simply replaces the end ring on the original hub cap provided by the manufacturer (see FIG. 11). The end ring 602 defines the threaded opening 605 at the center of the web portion 606 thereof and includes a standard array of apertures 607 in the perimeter portion 608 of the ring so that the end ring 602 can be secured in place with the same or similar screws 609 to those used by the manufacturer to secure the original sight glass carrying end ring in place.

The center hub 604 comprises a base portion 610, an annular outer flange 611 at the downstream end thereof and a projecting portion 612. A recess is provided in base portion 610 adjacent flange 611 for an o-ring 617. The base portion 610 is provided with external threads 613 thereon that adapted to engage the internal threads 605 about the central aperture 615 in the end ring 602. In hub caps without sight glasses, the base portion of center hub 604 would threadably engage the internal threads formed about the 1.625 inch diameter aperture formed in the hub cap end wall. The projecting portion 612 of hub 604 is integrally formed with the base portion 610 and is inwardly spaced from the perimeter of the base portion so as to define an annular recess therebetween for an o-ring 614. The projecting portion 612 also defines a threaded central bore 616 extending axially therethrough and a radially offset interior annular wall 618 having a plurality of inclined oil return apertures 620 formed therein. Apertures 620 are virtually identical in configuration and orientation to apertures 512 discussed above. The threaded central bore 616 is also virtually identical to the above-described threaded aperture 65 and is thus adapted to receive and threadably engage rotary union housing portion 64. The radially offset wall 618 defines an annular oil collection area 622 substantially identical to the above-described collection area 507 and the return apertures 620 in center hub 604 are identical to the inclined apertures 512 in the previously described annular wall 508. Thus, ring assembly 600 allows one to easily retrofit an existing hub cap to provide the same end wall configuration as if the hub cap were specifically manufactured for the present invention.

Finally, a warning light (not shown) is preferably provided so as to alert the driver in the event of the activation of the automatic tire inflation system, which would be indicative of a tire leak. In addition, if one were to disconnect one of air hoses 96 or 98 from its respective tire stem, the warning light would also illuminate so that the automatic tire inflation system would not continuously pump air through the system without the knowledge of the driver. Such a warning system could comprise a microswitch in electrical communication with the wiring harness on the trailer which closes upon the activation of the control unit in the automatic tire inflation system and triggers a transmitter which would send a signal to a receiving unit mounted on the front left corner of the trailer. The receiving unit would activate a light source such as a plurality of LED's which would be clearly visible to the driver through the side mirror of the attached tractor.

Various other changes and modifications may be made in carrying out the present invention without departing from the spirit and scope thereof. Insofar as these changes and modifications are within the purview of the appended claims, they are to be considered as part of the present invention.

1. A rotary union assembly for use in an automatic tire inflation system for maintaining a desired pressure in a plurality of pneumatic tires mounted on the wheels of a vehicle having a source of pressurized air for fluid communication with the tires through the axles and a hub cap at the end of each axle for providing a lubrication compartment for the wheel bearings, said assembly comprising:
a conduit support carried by an end of an axle and defining a channel extending axially therethrough;
a tubular conduit having a rigid portion and a flexible portion, said rigid portion extending axially through said conduit support and communicating with the interior of said axle;
a stationary shaft member having an air passageway extending axially therethrough and communicating with said tubular conduit;
a housing attachable to the exterior of a hub cap for rotation therewith, said housing defining a centrally disposed channel therein and being rotatably mounted on said stationary shaft member such that said air passageway in said shaft member communicates with said channel in said housing, whereby airflow is directed from said axle through said tubular conduit and said stationary shaft member to said rotatable housing; and
an air hose assembly communicating said centrally disposed channel in said rotatable housing with at least one of the vehicle tires.

2. The assembly of claim 1 wherein said stationary shaft member defines a stationary planar bearing surface at one end thereof and including a rotary sealing member mounted within said air passageway in said housing for rotation with said housing, said rotary sealing member having an air passageway extending therethrough and communicating with said air passageway in said shaft member and defining a rotary planar bearing surface disposed parallel to and in abutment with said stationary planar bearing surface on said shaft, said bearing surfaces being disposed exteriorly of the lubrication compartment.

3. A rotary union assembly for use in an automatic tire inflation system for maintaining a desired pressure in a plurality of pneumatic tires mounted on the wheels of a vehicle having a source of pressurized air for fluid communication with the tires through the axles and a hub cap at the end of each axle for providing a lubrication compartment for the wheel bearings said assembly comprising:
a conduit support carried by an end of an axle and defining a channel extending axially therethrough;
a tubular conduit having a rigid portion and a flexible portion, said flexible portion being axially aligned with and downstream of said rigid portion, said rigid portion extending axially through said conduit support and communicating with the interior of said axle whereby a sealed air flow conduit can be provided between said annular sealing member in said conduit support and said shaft member when said shaft member is out of axial alignment with said conduit supports
a stationary shaft member having an air passageway extending axially therethrough and communicating with said tubular conduit;
a housing attachable to a hub cap for rotation therewith, said housing defining a centrally disposed channel therein and being rotatably mounted on said stationary shaft member such that said air passageway in said shaft member communicates with said channel in said housing, where by airflow is directed from said axle through said tubular conduit and said stationary shaft member to said rotatable housing; and
an air hose assembly communicating said centrally disposed channel in said rotatable housing with at least one of the vehicle tires.

4. The assembly of claim 1 including an annular sealing member disposed within said conduit support, said sealing member forming an airtight seal between said conduit support and said rigid portion of said tubular conduit and wherein said flexible portion of said tubular conduit is disposed between said rigid portion of said conduit and said shaft member whereby a sealed air flow conduit can be provided between said annular scaling member in said conduit support and said shaft member when said shaft member is out of axial alignment with said conduit support.

5. The assembly of claim 1 wherein said housing includes at least one pressure relief channel extending axially therethrough, said channel defining an upstream end communicating with the interior of said hub cap upon said housing being attached to the hub cap and a downstream end communicating with the atmosphere exteriorly of the hub cap, a valve member slidably mounted within said channel and moveable between an open position and a closed position and a spring member biasing said valve member to said closed position so as to prevent fluid flow therethrough, said spring member being responsive to a pressure build-up within the lubrication compartment so as to move said valve member to said open position upon said pressure build-up reaching a predetermined level whereby air in the lubrication compartment passes through said pressure relief channel to the atmosphere reducing the pressure build-up within the lubrication compartment.

6. The assembly of claim 3 including at least one pressure responsive relief valve disposed within said housing for preventing pressure buildups above a predetermined level in the interior of the hub cap and in the central housing channel in the event of an air leak in the tire inflation system, said valve communicating with both the interior of the hub cap and said central housing channel upon said housing being attached to said hub cap and venting the interior of the hub cap and said channel to atmosphere upon the pressure within said hub cap or said channel reaching said predetermined level.

7. The assembly of claim 3 including at least one pressure relief valve disposed within said housing for preventing pressure buildups above a predetermined level in the interior of the hub cap and in the central housing channel in the event of an air leak in the tire inflation system, an air passageway at least partially defined by said housing, said pressure relief valve communicating with the central housing channel and, upon said housing being attached to the hub cap, with the interior of the hub cap through said air passageway and venting the interior of the hub cap and said central housing channel to atmosphere upon the pressure within the hub cap or said channel reaching said predetermined level, and an oil shield at least partially occluding said air passageway so as to inhibit the passage of oil from the hub cap into said passageway as said valve vents the interior of the hub cap to atmosphere.

8. The assembly of claim 7 wherein said oil shield extends transversely of said air passageway so as to deflect oil outwardly and away from said air passageway and including an annular channel radially spaced from said shield for collecting oil deflected by said shield and a plurality of oil return apertures in said channel for directing the collected oil back into the interior of the hub cap in response to centrifugal force acting on the collected oil as the hub cap rotates on the vehicle.

9. The assembly of claim 5 including a weep hole communicating said pressure relief channel with said centrally disposed channel in said housing whereby upon a pressure build-up within said channel reaching said predetermined level will move to said valve member to said position whereby air in said central housing channel passes through said pressure relief channel to the atmosphere reducing the pressure build-up within said central housing channel.

10. The assembly of claim 4 wherein said housing includes at least one pressure relief channel extending axially therethrough, said channel defining an upstream end communicating with the interior of said hub cap upon said housing being attached to the hub cap and a downstream end communicating with the atmosphere exteriorly of the hub cap, a valve member slidably mounted within said channel and moveable between an open position and a closed position and a spring member biasing said valve member to said closed position so as to prevent fluid flow therethrough, said spring member being responsive to a pressure build-up within the lubrication compartment so as to move said valve member to said open position upon said pressure build-up reaching a predetermined level whereby air in the lubrication compartment passes through said pressure relief channel to the atmosphere reducing the pressure build-up within the lubrication compartment.

11. The assembly of claim 4 wherein said flexible portion of said tubular conduit is axially aligned with and downstream of said rigid portion whereby a sealed air flow conduit can be provided between said annular scaling member in said conduit support and said shaft member when said shaft member is out of axial alignment with said conduit support.

12. A rotary union assembly for use in an automatic tire inflation system for maintaining a desired pressure in a plurality of pneumatic tires mounted on the wheels of a vehicle having a source of pressurized air for fluid communication with the tires through the axles and a hub cap at the end of each axle for providing a lubrication compartment for the wheel bearings, said assembly comprising:
a spindle plug assembly adapted to be mounted in an end of an axle in a stationary disposition for communicating the source of pressurized air through the axle with said rotary union assembly, said spindle plug assembly defining a channel extending axially therethrough;
an annular sealing member disposed in said spindle plug assembly about said channel therein;
a tubular conduit having a rigid portion and a flexible portion, said flexible portion being axially aligned with and downstream of said rigid portion and said rigid portion being adapted to extend axially through said channel in said spindle plug assembly and communicate with the interior of said axle such that said sealing member engages said rigid portion of said tubular conduit and forms an airtight seal therewith;
a stationary rigid shaft member having an air passageway extending axially therethrough for communicating with said tubular conduit;
a housing attachable to the exterior of a hub cap for rotation therewith, said housing defining a centrally disposed channel therein and being rotatably mounted on said stationary shaft member such that said air passageway in said shaft member communicates with said channel in said housing, where by airflow is directed from said axle through said tubular conduit and said stationary shaft member to said rotatable housing; and
an air hose assembly communicating said centrally disposed channel in said rotatable housing with at least one of the vehicle tires.

13. The assembly of claim 12 wherein said stationary shaft member defines a stationary planar bearing surface at one end thereof and including a rotary sealing member mounted within said air passageway in said housing for rotation with said housing, said rotary sealing member having an air passageway extending therethrough and communicating with said air passageway in said shaft member and defining a rotary planar bearing surface disposed parallel to and in abutment with said stationary planar bearing surface on said shaft, said bearing surfaces being disposed exteriorly of the lubrication compartment.

14. The assembly of claim 12 including at least one pressure responsive relief valve disposed within said housing for preventing pressure buildups above a predetermined level in the interior of the hub cap and in the central housing channel in the event of an air leak in the tire inflation system, said valve communicating with both the interior of the hub cap and said central housing channel upon said housing being attached to said hub cap and venting the interior of the hub cap and said channel to atmosphere upon the pressure within said hub cap or said channel reaching said predetermined level.

15. The assembly of claim 12 wherein said housing includes at least one pressure relief channel extending axially therethrough, said channel defining an upstream end communicating with the interior of said hub cap upon said housing being attached to the hub cap and a downstream end communicating with the atmosphere exteriorly of the hub cap, a valve member slidably mounted within said channel and moveable between an open position and a closed position and a spring member biasing said valve member to said closed position so as to prevent fluid flow therethrough, said spring member being responsive to a pressure build-up within the lubrication compartment so as to allow said valve member to move to said open position upon said pressure build-up reaching a predetermined level whereby air in the lubrication compartment passes through said pressure relief channel to the atmosphere reducing the pressure build-up within the lubrication compartment.

16. The assembly of claim 12 including at least one pressure relief valve disposed within said housing for preventing pressure buildups above a predetermined level in the interior of the hub cap and in the central housing channel in the event of an air leak in the tire inflation system, an air passageway at least partially defined by said housing, said pressure relief valve communicating with said central housing channel and, upon said housing being attached to the hub cap, with the interior of the hub cap through said air passageway and venting the interior of the hub cap and the central housing channel to atmosphere upon the pressure within the hub cap or said channel reaching said predetermined level, and an oil shield at least partially occluding said air passageway so as to inhibit the passage of oil from the hub cap into said passageway as said valve vents the interior of the hub cap to atmosphere.

17. The assembly of claim 16 wherein said oil shield extends transversely of said air passageway so as to deflect oil outwardly and away from said air passageway and including an annular channel radially spaced from said shield for collecting oil deflected by said shield and a plurality of oil return apertures in said channel for directing the collected oil back into the interior of the hub cap in response to centrifugal force acting on the collected oil as the hub cap rotates on the vehicle.

18. The assembly of claim 15 including a weep hole communicating said pressure relief channel with said centrally disposed channel in said housing whereby upon a pressure build-up within said channel reaching said predetermined level will move to said valve member to said position whereby air in said central housing channel passes through said pressure relief channel to the atmosphere reducing the pressure build-up within said central housing channel.

19. The assembly of claim 12 wherein said housing includes a pair of pressure relief valves communicating with the interior of said hub cap upon said housing being attached to the hub cap, one of said valves additionally communicating with the central channel housing, said valves being moveable between an open position and a closed position such that in said open position, said valves vent the interior of the hub cap to atmosphere and said one valve additionally vents the central housing channel to atmosphere, and wherein said pressure relief valves are disposed in said closed position when the air pressures within the hub cap and central housing channel are below a predetermined level and in an open position when the air pressure within the hub cap is above said level, said one valve additionally opening when the air pressure within said central channel housing is above said level whereby deleterious pressure build-ups within said hub cap and said central channel housing are prevented.

20. The assembly of claim 19 wherein said housing includes at least one pressure relief channel extending axially therethrough, said channel defining an upstream end communicating with the interior of said hub cap upon said housing being attached to the hub cap and a downstream end communicating with the atmosphere exteriorly of the hub cap, a valve member slidably mounted within said channel and moveable between an open position and a closed position and a spring member biasing said valve member to said closed position so as to prevent fluid flow therethrough, said spring member being responsive to a pressure build-up within the lubrication compartment so as to allow said valve member to move to said open position upon said pressure build-up reaching a predetermined level whereby air in the lubrication compartment passes through said pressure relief channel to the atmosphere reducing the pressure build-up within the lubrication compartment.

21. The assembly of claim 19 wherein said pressure relief valves each comprise a pressure relief channel extending axially through said housing, a valve member axially moveable within said pressure relief channel between said open position and said closed position and a spring member biasing said valve member to said closed position.

22. The assembly of claim 21 wherein said predetermined level is about 0.5 psi above atmospheric pressure.

23. A housing assembly for a rotary union in an automatic tire inflation system for communicating the rotary union with a source of pressurized air and a plurality of pneumatic tires mounted on the wheels of a vehicle having a source of pressurized air for fluid communication with the tires through the axles and a hub cap at the end of each axle for providing a lubrication compartment for the wheel bearings, said housing assembly defining a central channel therein for containing the rotary union and being attachable to the exterior of the hub cap for rotation therewith such that said central channel is communicable with the source of pressurized air through the axle, and wherein said housing assembly includes at least one pressure responsive relief valve disposed within said housing for preventing pressure buildups above a predetermined level in the interior of the hub cap and in the central housing channel in the event of an air leak in the tire inflation system, said valve communicating with both the interior of the hub cap and the central housing channel upon said housing being attached to said hub cap and venting the interior of the hub cap and said channel to atmosphere upon the pressure within said hub cap or said channel reaching said predetermined level.

24. A housing assembly for a rotary union in an automatic tire inflation system for communicating the rotary union with a source of pressurized air and a plurality of pneumatic tires mounted on the wheels of a vehicle having a source of pressurized air for fluid communication with the tires through the axles and a hub cap at the end of each axle for providing a lubrication compartment for the wheel bearings, said housing assembly defining a central channel therein for containing the rotary union and being attachable to the hub cap for rotation therewith such that said central channel is communicable with the source of pressurized air through the axle, and wherein said housing assembly includes at least one pressure relief channel extending axially therethrough, said channel defining an upstream end communicating with the interior of said hub cap upon said housing being attached to the hub cap and a downstream end communicating with the atmosphere exteriorly of the hub cap, a valve member slidably mounted within said channel and moveable between an open position and a closed position and a spring member biasing said valve member to said closed position so as to prevent fluid flow therethrough, said spring member being responsive to a pressure build-up within the lubrication compartment so as to move said valve member to said open position upon said pressure build-up reaching a predetermined level whereby air in the lubrication compartment passes through said pressure relief channel to the atmosphere reducing the pressure build-up within the lubrication compartment.

25. The housing assembly of claim 24 including a weep hole communicating said pressure relief channel with said centrally disposed channel in said housing whereby upon a pressure build-up within said channel reaching said predetermined level will move to said valve member to said position whereby air in said central housing channel passes through said pressure relief channel to the atmosphere reducing the pressure build-up within said central housing channel.

26. The housing assembly of claim 24 including an air passageway at least partially defined by said housing assembly and communicating said upstream end of said pressure relief channel with the interior of said hub cap upon said housing assembly being attached to said hub cap.

27. The housing assembly of claim 24 wherein said housing includes an upstream portion, said upstream portion threadably engaging the hub cap and including an air passageway at least partially defined by said upstream portion of said housing assembly and communicating said upstream end of said pressure relief channel with the interior of said hub cap upon said housing assembly being attached to said hub cap.

28. The housing assembly of claim 25 including an air passageway at least partially defined by said housing assembly and communicating said upstream end of said pressure relief channel with the interior of said hub cap upon said housing assembly being attached to said hub cap.

29. The housing assembly for the rotary union in an automatic tire inflation system for communicating the rotary union with a source of pressurized air and a plurality of pneumatic tires mounted on the wheels of a vehicle having a source of pressurized air for fluid communication with the tires through the axles and a hub cap at the end of each axle for providing a lubrication compartment for the wheel bearings, said housing assembly defining a central channel therein for containing the rotary union and being attachable to the exterior of the hub cap for rotation therewith such that said central channel is communicable with the source of pressurized air through the axle, and wherein said housing assembly includes a pair of pressure relief channels extending axially therethrough, said channel defining an upstream end communicating with the interior of said hub cap upon said housing being attached to the hub cap and a downstream end communicating with the atmosphere exteriorly of the hub cap, a valve member slidably mounted within said channel and moveable between an open position and a closed position and a spring member biasing said valve member to said closed position so as to prevent fluid flow therethrough, said spring member being responsive to a pressure build-up within the lubrication compartment so as to move said valve member to said open position upon said pressure build-up reaching a predetermined level whereby air in the lubrication compartment passes through said pressure relief channel to the atmosphere reducing the pressure build-up within the lubrication compartment.

30. (canceled)

31. The assembly of claim 29 wherein said predetermined level is about 0.5 psi above atmospheric pressure.

32. The housing assembly of claim 29 including an air passageway at least partially defined by said housing assembly and communicating said upstream end of said pressure relief channel with the interior of said hub cap upon said housing assembly being attached to said hub cap.

33. The housing assembly of claim 29 wherein said housing includes an upstream portion, said upstream portion threadably engaging the hub cap and including an air passageway at least partially defined by said upstream portion of said housing assembly and communicating said upstream end of said pressure relief channel with the interior of said hub cap upon said housing assembly being attached to said hub cap.

34. The assembly of claim 29 wherein said valve members define air outlet orifices therein and wherein said orifices and said pressure relief channels are configured such that when said valve members are in said open position in response to an air leak and the source of pressurized air directs air into the interior of the hub cap up to about 125 psi, said pressure relief channels and air outlet orifices will evacuate sufficient air therethrough so as to prevent a pressure buildup within the hub cap of over 5 psi.

35. The assembly of claim 29 wherein said predetermined level is about 0.5 psi above atmospheric pressure, said valve members define air outlet orifices therein and wherein said orifices and said pressure relief channels are configured such that when said valve members are in said open position in response to an air leak and the source of pressurized air directs air into the interior of the hub cap up to about 125 psi, said pressure relief channels and air outlet orifices will evacuate sufficient air therethrough so as to prevent a pressure buildup within the hub cap of over 5 psi.

36. The rotary union assembly of claim 1 wherein said air hose assembly comprises an air hose, a first fitting carried by said housing and communicating with said channel therein, a first pressure actuated check valve disposed within said first fitting, a second fitting carried by a first end portion of said air hose, said second fitting being adapted to be coupled with said first fitting and hold said check valve in an open position such that air can pass therethrough into said air hose, a third fitting carried by a second end of said air hose, said third fitting being adapted to be coupled with the vehicle tire, and a second pressure actuated check valve carried by said third fitting for preventing air loss from the vehicle tire in the event of an air leak in said air hose.

37. The rotary union assembly of claim 36 wherein said second check valve is actuated to a closed position to prevent air flow therethrough in the event of a pressure imbalance thereacross of at least about 3 psi.

38. A rotary union assembly for use in an automatic tire inflation system for maintaining a desired pressure in a plurality of pneumatic tires mounted on the wheels of a vehicle of a type having a source of pressurized air for fluid communication with the tires through the axles and a hub cap at the end of each axle for providing a lubrication compartment for the wheel bearings, said assembly comprising:
a conduit support carried by an end of an axle and defining a channel extending axially therethrough;
an annular sealing member disposed in said conduit support about said channel therein.
a stationary tubular conduit defining an upstream end portion and a downstream end portion, said upstream end portion extending axially through said conduit support and communicating with the interior of said axle, said sealing member engaging said tubular conduit and forming an airtight seal within said conduit support about said tubular conduit;
a housing attachable to the exterior of a hub cab for rotation therewith, said housing defining at least one air passageway extending therethrough and being rotatably mounted on said downstream end portion of said tubular conduit such that said tubular conduit communicates the interior of said axle with said air passageway in said housing, whereby air flow is directed from said axle through said stationary tubular conduit to said rotatable housing; and
an air hose assembly communicating said air passageway in said rotatable housing with at least one of the vehicle tires, said air hose assembly comprising, an air hose, a first fitting carried by said housing and communicating with said air passageway therein, a first pressure actuated check valve disposed within said first fitting, a second fitting carried by a first end portion of said air hose, said second fitting being adapted to be coupled with said first fitting and hold said check valve in an open position such that air can pass therethrough into said air hose, a third fitting carried by a second end of said air hose, said third fitting being adapted to be coupled with the vehicle tire, and a second pressure actuated check valve carried by said third fitting for preventing air loss from the vehicle tire in the event of an air leak in said air hose.

39. The rotary union assembly of claim 38 wherein said second pressure actuated check valve is actuated to a closed position to prevent air flow therethrough in the event of a pressure imbalance thereacross of at least about 3 psi.

40. The rotary union assembly of claim 38 wherein the upstream portion of said stationary tubular conduit includes a rigid portion and a flexible portion, the rigid portion extending axially through said conduit support and communicating with the interior of said axle and wherein the downstream portion of said tubular conduit comprises a stationary shaft member having an air passageway extending axially therethrough and communicating with said upstream portion of said tubular conduit.

41. A rotary union assembly for use in an automatic tire inflation system for maintaining a desired pressure in a plurality of pneumatic tires mounted on the wheels of a vehicle having a source of pressurized air for fluid communication with the tires through the axles and a hub cap at the end of each axle for providing a lubrication compartment for the wheel bearings, said assembly comprising:
a conduit support carried by an end of an axle and defining a channel extending axially therethrough;
a tubular conduit having a rigid portion and a flexible portion, said rigid portion extending axially through said conduit support and communicating with the interior of said axle;
a stationary shaft member having an air passageway extending axially therethrough and communicating with said tubular conduit;
a housing attachable to the exterior of a hub cap for rotation therewith, said housing defining a centrally disposed channel therein and being rotatably mounted on said stationary shaft member such that said air passageway in said shaft member communicates with said channel in said housing, whereby airflow is directed from said axle through said tubular conduit and said stationary shaft member to said rotatable housing;
a rotary union comprising a rotary element and a stationary element, said rotary union being disposed in said central channel in said housing; and
an air hose assembly communicating said centrally disposed channel in said rotatable housing with at least one of the vehicle tires.

42. A rotary union assembly for use in an automatic tire inflation system for maintaining a desired pressure in a plurality of pneumatic tires mounted on the wheels of a vehicle having a source of pressurized air for fluid communication with the tires through the axles and a hub cap at the end of each axle for providing a lubrication compartment for the wheel bearings, said assembly comprising:
a conduit support carried by an end of an axle and defining a channel extending axially therethrough;
a tubular conduit having a rigid portion and a flexible portion, said flexible portion being axially aligned with and downstream of said rigid portion and wherein said rigid portion extends axially through said conduit support and communicates with the interior of said axle;
a housing attachable to the exterior of a hub cap for rotation therewith, said housing defining a centrally disposed channel therein for communicating with the source of pressurized air through said tubular conduit;
a rotary union comprising a rotary element and a stationary element, said rotary union being disposed in said central channel in said housing; and
an air hose assembly communicating said centrally disposed channel in said rotatable housing with at least one of the vehicle tires.

43. The rotary union assembly of claim 42 including a sealing member carried by said conduit support and interacting with said rigid portion of said tubular conduit to inhibit rotation of said tubular conduit while allowing said tubular conduit to be axially translatable with respect to said end of said axle.

44. The assembly of claim 42 wherein said housing includes at least one pressure relief channel extending axially therethrough, said channel defining an upstream end communicating with the interior of said hub cap upon said housing being attached to the hub cap and a downstream end communicating with the atmosphere exteriorly of the hub cap, a valve member slidably mounted within said channel and moveable between an open position and a closed position and a spring member biasing said valve member to said closed position so as to prevent fluid flow therethrough, said spring member being responsive to a pressure build-up within the lubrication compartment so as to move said valve member to said open position upon said pressure build-up reaching a predetermined level whereby air in the lubrication compartment passes through said pressure relief channel to the atmosphere reducing the pressure build-up within the lubrication compartment.

45. A rotary union assembly for use in an automatic tire inflation system for maintaining a desired pressure in a plurality of pneumatic tires mounted on the wheels of a vehicle having a source of pressurized air for fluid communication with the tires through the axles and a hub cap at the end of each axle for providing a lubrication compartment for the wheel bearings, said assembly comprising:
a conduit support carried by an end of an axle and defining a channel extending axially therethrough;
a tubular conduit having a rigid portion and a flexible portion, said rigid portion extending axially through said conduit support and communicating with the interior of said axle;
a stationary shaft member having an air passageway extending axially therethrough and communicating with said tubular conduit;
a housing attachable to the exterior of a hub cap for rotation therewith, said housing defining a centrally disposed channel therein and being rotatably mounted on said stationary shaft member such that said air passageway in said shaft member communicates with said channel in said housing, whereby airflow is directed from said axle through said tubular conduit and said stationary shaft member to said rotatable housing;
a rotary union comprising a rotary element and a stationary element, said rotary union being disposed in said central channel in said housing; and
an air hose assembly communicating said air passageway in said rotatable housing with at least one of the vehicle tires, said air hose assembly comprising, an air hose, a first fitting carried by said housing and communicating with said air passageway therein, a first pressure actuated check valve disposed within said first fitting, a second fitting carried by a first end portion of said air hose, said second fitting being adapted to be coupled with said first fitting and hold said check valve in an open position such that air can pass therethrough into said air hose, a third fitting carried by a second end of said air hose, said third fitting being adapted to be coupled with the vehicle tire, and a second pressure actuated check valve carried by said third fitting for preventing air loss from the vehicle tire in the event of an air leak in said air hose.

46. The assembly of claim 45 wherein said flexible portion of said tubular conduit is axially aligned with and downstream of said rigid portion whereby a sealed air flow conduit can be provided between said annular sealing member in said conduit support and said shaft member when said shaft member is out of axial alignment with said conduit support.
